(19) United States
(12) Patent Application Publication
(10) Pub. No.: US 2004/0253086 A1
(43) Pub. Date: Dec. 16, 2004

(54) Lifting apparatus

(76) Inventor: Grant Dixon, New South Wales (AU)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/478,883

(22) PCT Filed: May 21, 2002
(86) PCT No.: PCT/AU02/00634

(30) Foreign Application Priority Data
May 21, 2001 (AU) PR 5180

(51) Int. Cl. B62B 1/00

(52) U.S. Cl. 414/490

(57) ABSTRACT

The present invention provides a lifting trolley for lifting and conveying an object, the lifting trolley includes a frame having an operatively lower wheeled end supported on a wheel arrangement, and an operatively upper end, a lifting carriage slideably mounted on the frame, actuating means for moving the lifting carriage along the frame between lowered and raised positions, and object gripping means extending from the lifting carriage. The gripping means are adapted to grip the object to be conveyed and to allow the object to be lifted by operation of the actuating means on the lifting carriage. The preferred embodiment utilizes an object gripping means including a suction grip to form a forms a surface engaging grip on the object to be lifted.

### FIELD OF THE INVENTION

The present invention relates to a device to assist a person in lifting and conveying articles. In particular, the present invention relates to or hand-truck.

### BACKGROUND OF THE INVENTION

People are often required to move objects from one place to another. This task can be performed simply if the object to be moved is light in weight, small in size, and the distance of movement required is relatively short. However, moving objects from one place to another becomes more difficult if one or another of these conditions is not met. Moreover, the difficulty of moving objects can is enhanced if the person required to move the object is injured or otherwise physically unable to perform the task adequately.

Safety devices, such as back or kidney braces, are available which may be worn to ensure that a person lifting an article does not injure himself or herself. These devices are adapted to prevent injury rather than assist in lifting and thus they do not allow a person to lift an article, which would otherwise be too heavy for them to lift. Furthermore such devices may lull the wearer into a false sense of security and in fact encourage him or her to attempt to lift loads that they otherwise would not.

A particular problem relates to lifting objects which are only slightly too heavy, too large or awkward for a person to lift safely. These type of objects often require a lifting device such as a hand truck, to be used to lift and carry them, or require a second person to assist in lifting the object.

Hand truck are useful for moving articles in a first position at ground level to the second position also at ground level. However, hand trucks are of little assistance if the object must either, be lifted off, or placed on, an elevated surface, such as a tabletop or shelf.

### SUMMARY OF THE INVENTION

According to a first aspect of the present invention there is provided a lifting trolley for lifting and conveying an object, the lifting trolley including;

a frame having an operatively lower wheeled end supported on a wheel arrangement, and an operatively upper end;

a lifting carriage slideably mounted on the frame;

actuating means for moving the lifting carriage along the frame between lowered and raised positions;

object gripping means extending from the lifting carriage, the gripping means being adapted to grip the object to be conveyed and to allow the object to be lifted by operation of the actuating means on the lifting carriage.

Preferably the object gripping means is arranged to form a surface engaging grip on a surface of the object.

Preferably the object gripping means includes at least one releasable suction grip.

Preferably the object gripping means includes at least one releasable electromagnetic grip.

Preferably the object gripping means is rotatably or slidably mounted on the lifting carriage for allowing the orientation or position of an object to be adjusted when in a gripped position.

Preferably the trolley further includes object supporting means coupled to the lifting carriage and adapted to at least partially support the weight of the object.

Preferably the object supporting means includes a pair of support tines and/or a support platform.

Preferably the support platform includes glide means adapted to allow the object to be slid along the support platform until the object comes into surface engagement with the object gripping means. The glide means is preferably a ball mat.

Preferably the actuation means is selected from one of the following types of actuation means:

winch, hoist or jack.

In a preferred embodiment the frame is substantially L shaped, with the horizontal arm of the L constituting a support portion which maintains the trolley in a substantially vertical orientation when at rest.

Preferably the frame is substantially the shape of a right-triangle, wherein the lifting carriage is slideably mounted along a portion of the frame lying along the hypotenuse of the triangle such that an object gripped by the gripping means is ramped upwards at an acute angle with respect to a surface supporting the lifting trolley.

The object gripping means can be detachably mounted on the lifting carriage.

Preferably the lifting trolley includes a plurality of different types of object gripping means which can be interchangeably mounted on the lifting carriage, the object gripping means being selected from a group including:

a suction grip, an electromagnetic grip.

According to a second aspect of the present invention there is provided a lifting trolley for lifting and conveying an object, the lifting trolley including;

a frame having an operatively lower wheeled end supported on a wheel arrangement, and an operatively upper end;

a lifting carriage slideably mounted on the frame;

actuating means for moving the lifting carriage along the frame between lowered and raised positions;

object gripping means extending from the lifting carriage, the gripping means being adapted to engage the object to be conveyed in a surface engaging grip which relies on surface features of at least one face of the object rather than the dimensions or shape of the object.

Preferably the object gripping means includes at least one releasable suction grip.

Preferably the object gripping means includes at least one releasable electromagnetic grip. Because a suction grip or electromagnetic grip is not orientation or position sensitive, and does not interfere mechanically with the object, use of a suction grip or electromagnetic grip can reduce the manoeuvring that is required to position the object relative to the support carriage.

### BRIEF DESCRIPTION OF THE DRAWINGS

Notwithstanding any other forms, which may fall within the scope of the present invention, the present invention will now be described by way of example only with reference to the accompanying drawings in which:

FIG. 1A shows a side view of the lifting trolley according to the first embodiment of the present invention;

FIG. 1B shows a front view of the embodiment shown in FIG. 1A;

FIG. 2 shows partial cross-section of the embodiment of FIGS. 1A and 1B showing its lifting carriage, associated roller arrangement and lifting strap;

FIG. 3 shows a cross-sectional view through the frame of the lifting trolley of the embodiment of FIGS. 1A and 1B and the lifting carriage;

FIGS. 4A and 4B show a side view and front view respectively of a lifting trolley with a first type of object gripping means;

FIG. 5 shows a side view of a lifting carriage and associated object gripping means according to the embodiment shown in FIGS. 4A and 4B;

FIG. 6A and FIG. 6B show a side view and a front view of a further embodiment of the present invention with fork-type of object supporting means fitted;

FIGS. 7A and 7B show a lifting trolley according to an embodiment of the present invention with another type of object gripping means fitted;

FIG. 8 shows a front view of an object gripping means as shown in FIGS. 7A and 7B;

FIG. 9 shows a side view of a further embodiment of the present invention, having an auxiliary object gripping means;

FIG. 10 shows a front view of the embodiment of FIG. 9, with two slideably mounted auxiliary object gripping means;

FIG. 11 shows a side view of an auxiliary object gripping means as depicted in FIGS. 9 and 10;

FIG. 12 shows a side view of a lifting apparatus according to a second embodiment of the present invention with its object gripping means in a lowered position;

FIG. 13 shows a side view of the embodiment of FIG. 12 having its objection gripping means raised to an intermediate position;

FIG. 14 shows a plan view of the embodiment shown in FIGS. 12 and 13;

FIG. 15 shows a plan view of the embodiment shown in FIGS. 12 to 14 having its object gripping means raised to an intermediate position; and

FIG. 16 shows a side and partial cross-sectional view of the object gripping means of the embodiment of FIGS. 12 to 15 showing details of its mounting means.

### DETAILED DESCRIPTION OF THE EMBODIMENTS

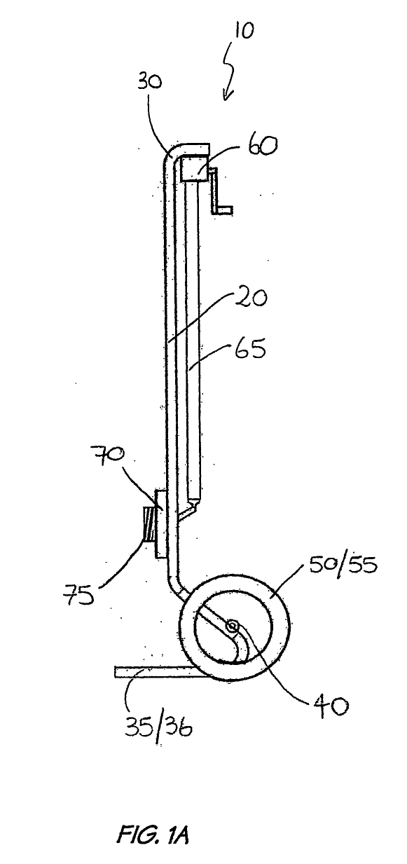

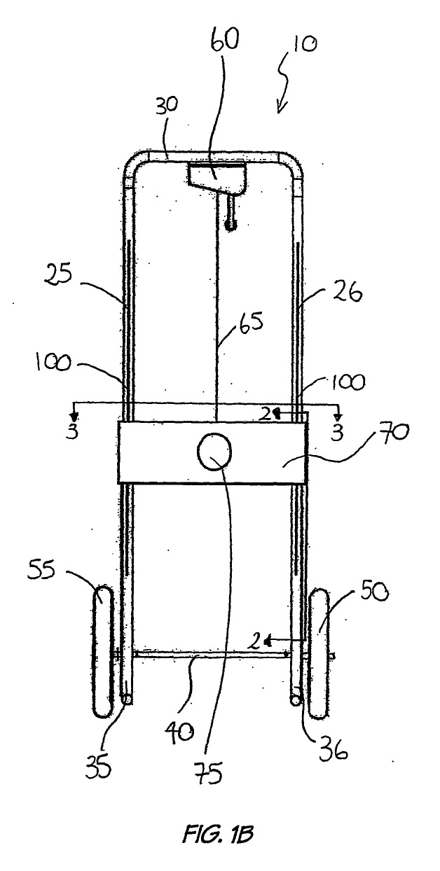

FIGS. 1A and 1B show a first embodiment of the lifting trolley 10 or hand-cart according to an embodiment of the present invention. Lifting trolley 10 includes a frame 20 comprised of a pair of slotted generally vertical frame members 25 and 26. The vertical frame members 25 and 26 each have a slot 100, extending substantially along the length of their vertical portion and further include, at their upper ends, a handle portion 30 and at their lower end a curved supporting foot 35 and 36 respectively. The apparatus feet 35 and 36 are generally S shaped, and have an axle 40 mounted at about the midpoint of the S-curve. Fitted on the ends of axle 40 is a pair of rotatable wheels 50 and 55. The mounting position of the axle 40 on the feet portions 35 and 36 and the diameter of the wheels 50 and 55 are chosen such that the horizontal lower portion of the supporting feet 35 and 36 are substantially coplanar with the perimeter of wheels 50 and 55, thus providing a stable support on which the trolley can rest in a substantially vertical orientation. Furthermore, the position of the axle 40 is chosen such that the centre of gravity of a load carried by the lifting trolley can be balanced substantially above the axle 40, thereby allowing safe and easy manoeuvring of the loaded trolley.

A lifting carriage 70 is slideably mounted on the frames 25, 26. The lifting carriage 70 is mounted on rollers which run along a channel inside the frame members 25, 26. The lifting carriage 70 has a threaded boss 75 centrally located thereon. Various lifting attachments or object gripping means may be affixed to said lifting carriage via the boss 75. A winch 60 is mounted at the centre of the handle portion 30 of the lifting trolley 10, and is attached via lifting strap 65 to the lifting carriage. The winch 60 operates as an actuating means to raise and or lower the lifting carriage 70 relative to the frame thereby lifting any object gripping means or object attached to the lifting carriage 70.

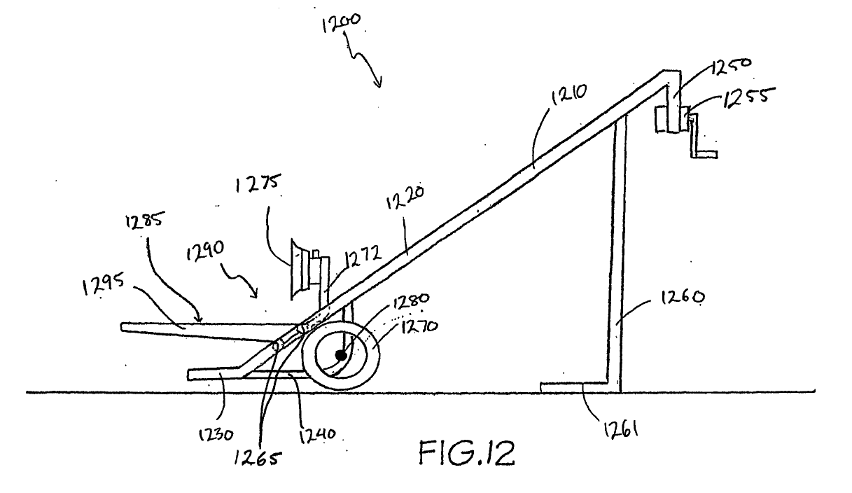

The lifting trolley 10 can be supported in an upright position by one or more support legs (not shown) which operate in a similar fashion to the support leg 1260 in FIG. 12. In a preferred embodiment the support leg can be hingedly or detachably mounted to the trolley frame, so that it can be stowed when not in use and moved into an operative position as required. As with support leg 1260 shown in FIG. 12, the foot of the, optional support leg of the present embodiment can include wheels or rollers to allow movement of the lifting trolley while it is supported on the leg.

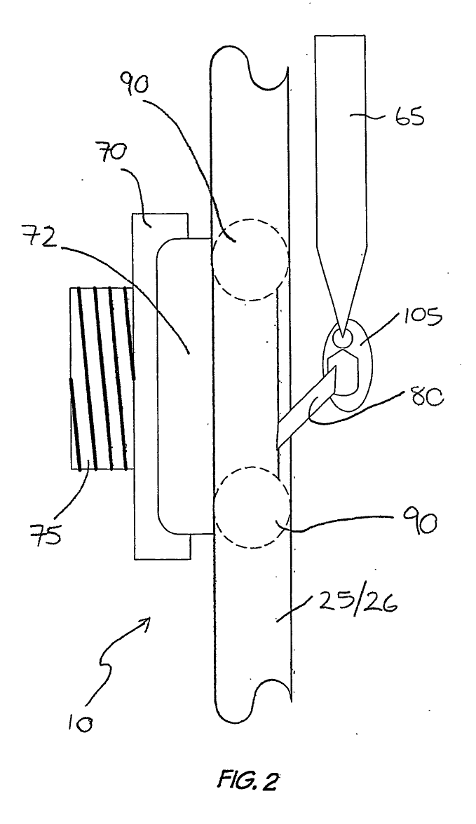

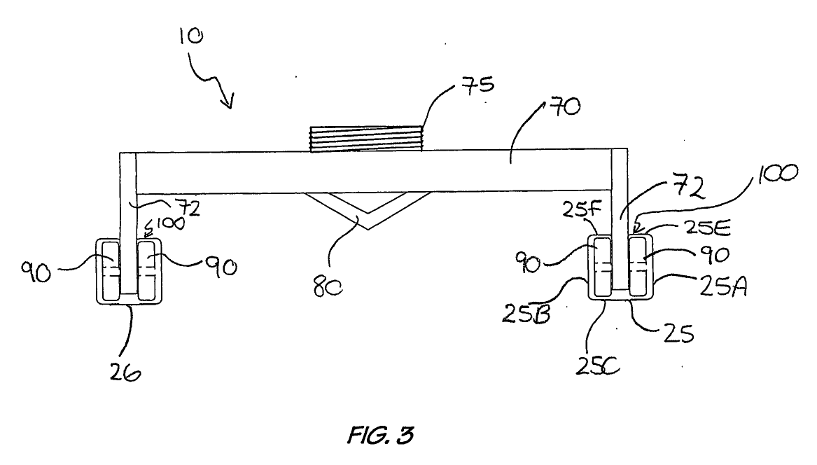

Turning now to FIGS. 2 and 3, each of which shows a cut-away view of portion of the lifting trolley 10. FIG. 2 shows a portion of the vertical frame members 25 or 26 and a side view of the lifting carriage 70 as viewed along line 2-2 in FIG. 1B. FIG. 2 also shows the means by which the lifting carriage 70 is slideably engaged with the frame portion of the lifting trolley. FIG. 3 shows a cross sectional view taken along line 3-3 of FIG. 1B, and shows the upright 25 and 26 of the lifting trolley 10 and a plan view of the lifting carriage 70.

As can be seen from FIG. 3 the lifting carriage 70 has a pair of flanges 72 extending at right angles from the rear edge thereof. The flanges 72 have mounted on their distal ends a plurality of rollers 90. The frame uprights 25 and 26 are generally C-shaped in cross-section. Turning to upright 25, the upright 25 has parallel side walls 25A and 25B with a web 25C extending therebetween. Walls 25A and 25B have a flange 25E and 25F respectively which are rolled inwardly from the walls. The facing edges of the flanges 25E and 25F define an elongated slot 100, which runs up the front of the frame member 25. Frame member 26 is identically configured.

The inside of frame members 25, 26 are sized such that they can receive into them a set of rollers 90 attached to the distal ends of the flanges 72 of the lifting carriage 70. Thus the inside of the frame uprights 25 and 26 retain the rollers and act as a track to facilitate smooth travel of the rollers 90 up the frame members 25, 26.

Attached to the rear face of the lifting carriage 70 is lifting lug 80 onto which the lifting strap 65 may be clipped when in use. On the front-most side of the lifting carriage 70 is located a threaded boss 75 onto which various lifting attachments or object gripping means may be affixed.

FIG. 2 shows a side view of the lifting carriage and an upright 25 or 26. The rollers 90 are rotatably mounted on flange 72 of the lifting carriage 70 and are housed within the uprights 25 and 26. The lifting strap 65 is attached via a clip 105 to the lifting lug 80 on the back of lifting carriage 70.

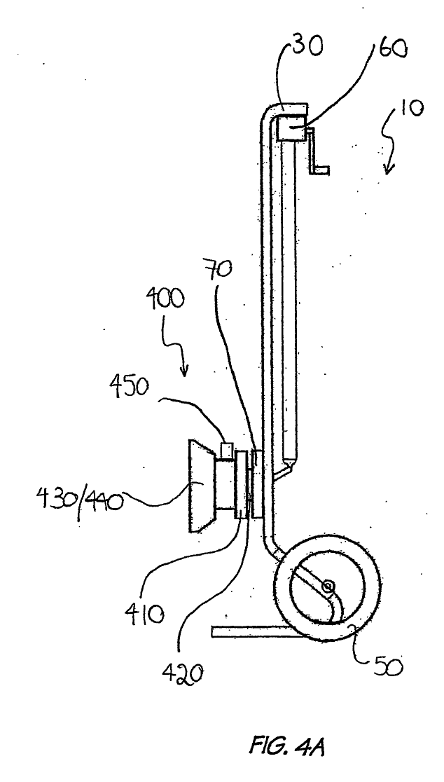

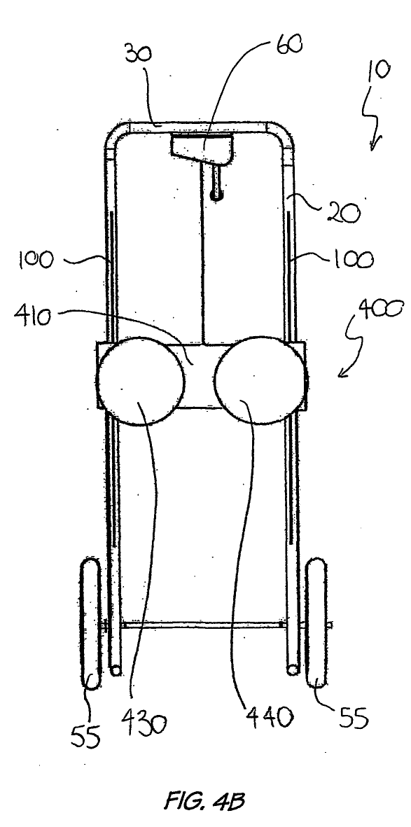

As described above the lifting carriage 70 is adapted to have object gripping means attached to it, to enable different types of objects to be lifted. Preferably such object gripping means are interchangeable. FIGS. 4A, 4B, 6A to 7B show embodiments of the lifting trolley 10 with a variety different object gripping means attached.

FIGS. 4A and 4B show side and front views respectively of a lifting trolley 10 of the embodiment of FIGS. 1A and 1B with a suction type object gripping means 400 mounted on the lifting carriage 70. The object gripping means 400 of this embodiment is adapted to lift an object with a substantially smooth surface, such as a television, refrigerator, car panel, pane of glass, or the like.

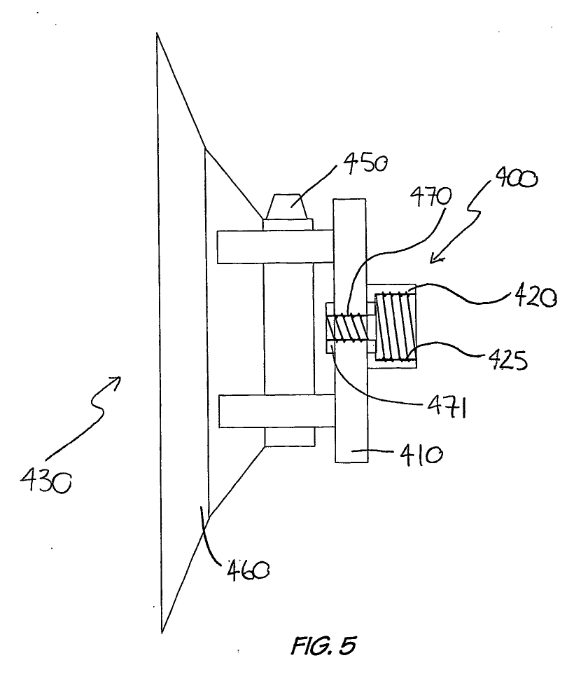

The object gripping means 400, a cross sectional view of which, is shown in FIG. 5, comprises a back-plate 410, on which is mounted a pair of suction grips 430 and 440, one of which is shown in FIG. 5. The back-plate 410 is attached to the lifting carriage via a threaded collar 420 located on its rear face. The suction grips include a pliable skirt 460 with a cuplike recess therein, which is maintained in fluid communication with a pump 450. In use the skirt 460 is adapted to conform to a surface and make an air tight seal with it. The pump 450 is then used to create a relative vacuum in the recess within the skirt and thereby create a sucking force between the suction grip and the surface, which securely fixes the suction grip to the surface.

Suitable suction grips are available from Australian Glass tools and are marketed as model number S109. Suction grips of this type are known which can carry loads in excess of 200 kg each.

In use the lifting trolley is wheeled into position such that the object gripping means is adjacent to the object to be lifted with the suction grips in contact with a surface of the object suitable for engagement using a suction force. Preferably the surface is smooth, and non air permeable. Preferably the surface is flat, however a mildly contoured or curved surfaces are also suitable. Once the suction grips 430/440 are in contact with a surface of the object a suction can be created in the grips 430/440 as discussed above, thereby creating a gripping force on the object.

The object can then be lifted off the surface on which it is resting in one of two ways. The object can be lifted by the operator of the lifting truck by pulling backward on the trolley handle 30 without allowing the wheels to roll, thereby using the frame 20 as a lever, pivoted on the axle 40 as a fulcrum, to lift the object. This lifting method is suitable for lifting the object a small way above the surface on which it is supported.

The second means for lifting the object is using the winch 60. When the winch 60 is wound the object held by the gripping means 400 and supported on the lifting carriage 70 is pulled up the frame uprights 25, 26, thereby lifting the object. Using the winch 60 the object can be raised off its supporting surface until the lifting carriage is raised to the top of slot 100. Clearly once the object is raised it can be moved by the trolley operator by simply pushing the trolley on its wheels 50/55 and lowered in a desired position.

It is a preferred feature of the winch 60 that it has a ratchet mechanism, which prevents the accidental lowering or dropping of the object being carried. In a particularly preferred embodiment the winch is adapted such that in order to lower the object, the winch handle must also be wound. This is particularly advantageous as the winch can thereby be used to lower the object in a more controlled manner than if the object is lowered by releasing the ratchet mechanism. A self-braking winch may also be employed. It should be noted that other types of actuation means may also be used, for example one or more jacks can be mounted on the lower end of the frame and be used to push the lifting carriage upward. Furthermore an endless chain attached to the lifting carriage and engaged with windable sprocket could also be used to move the lifting carriage. Alternatively said actuating means can be a jack, screw jack, scissor jack, hydraulic jack.

As can be seen in FIG. 5 the back-plate 410 of the object gripping means is fastened to the threaded collar 420 by way of a bolt 470 and nut 471. It is preferable that the bolt and nut are fastened such that the back-plate 410 can be rotated relative to the collar 420, and thus also relative to the lifting carriage 70 and trolley 10. By allowing rotation of the object gripping means 400 relative to the trolley 10, an object being carried can be rotated to allow access through narrow doorways etc. without lowering the object, tipping it over and re-lifting the object in its new orientation. Other types of swivel means may also be suitable. Furthermore a locking apparatus such as a spring loaded pin or, second bolt between the lifting carriage 70 and back-plate 410, can be used to lock the object gripping means 400 in a desired orientation relative to the trolley 10.

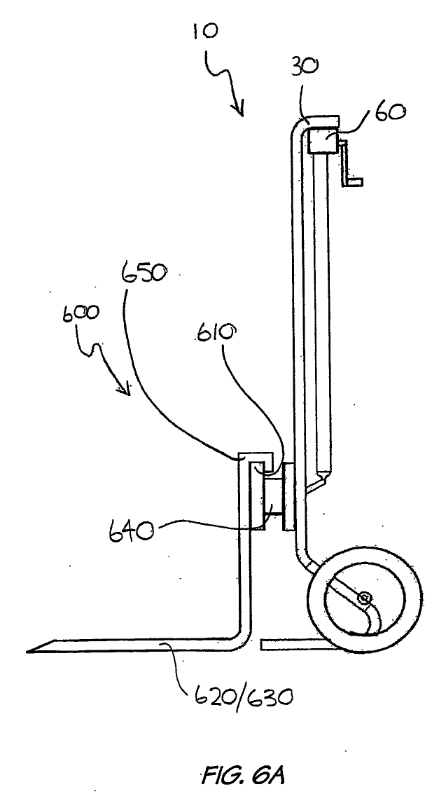

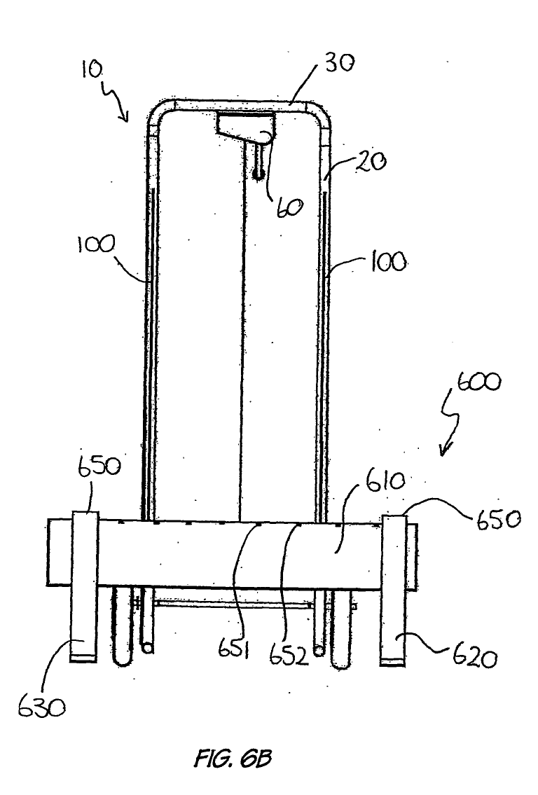

Turning now to FIGS. 6A and 6B which show a lifting trolley 10 similar to that of FIGS. 1 and 4, having attached to it a fork-lift type object supporting means 600. By using a combination of suction grips, or other surface engaging gripping means, and object support means such as fork-lift tines loads can be carried more securely.

This embodiment is adapted to lift objects having a supportive base such as pallets, boxes, crates, or the like. The object supporting means 600 comprises a pair of tines 620 and 630 supported on a bearer member 610. The bearer member 610 is mounted on the lifting carriage by a threaded sleeve 640, which is screwed onto threaded boss 75 (not shown). In this embodiment it is preferable that the object supporting means 600 cannot rotate relative to the trolley 10, as in the previous embodiment.

As can be seen in FIG. 6A the upper end of the tines 620, 630 terminate in hooked portions 650 which hook over the top of bearer member 610 in order to support the tines. The tines 620, 630 can additionally include a locking mechanism to releasably secure them from sliding along the bearer member 610. In the embodiment shown the bearer member 610 has a plurality of spaced apart notches eg. 651 and 652 on its top edge, which cooperate with complimentary projections (not shown) on the underside of the hooked ends of the tines 620/630 to maintain the desired tine spacing.

The manner of use of this embodiment of object gripping means is similar to that of a traditional motorised fork-lift. The free end of the tines 620/630 are slid under the object to be lifted. The object can then be lifted by either tilting the trolley 10 or using the winch 30 to raise the tines 620/630 relative to the trolley 10. One or more object gripping means can then be used to secure the object to be conveyed relative to the lifting carriage, while it is raised and the object conveyed to a desired location.

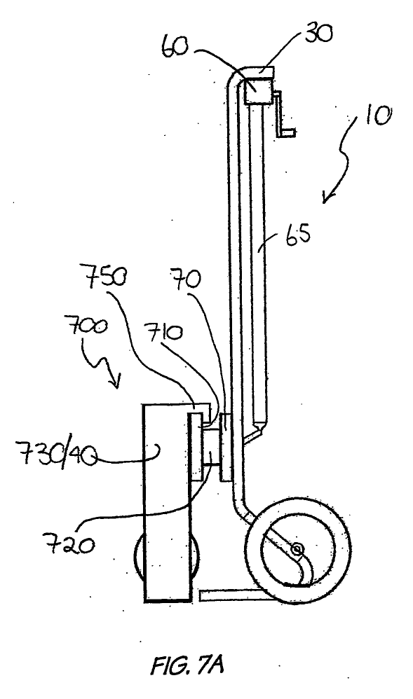

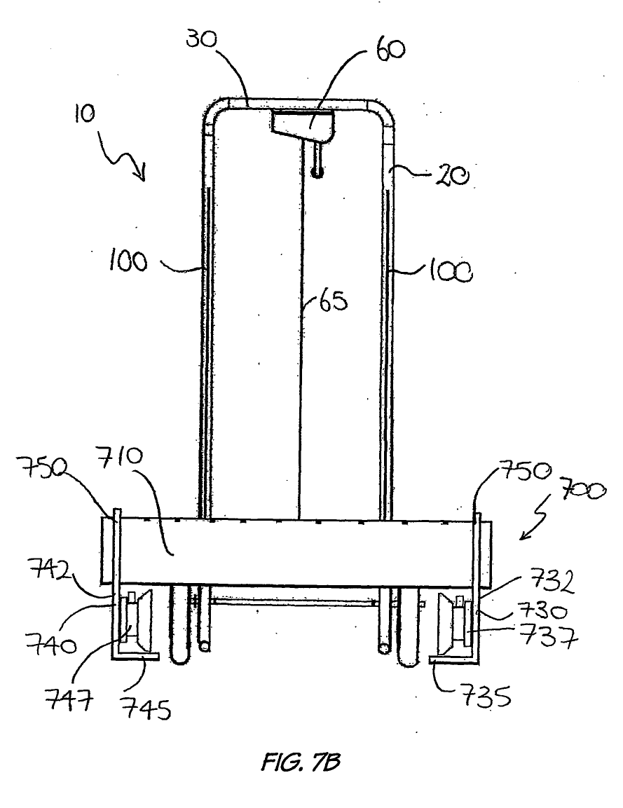

Turning now to FIGS. 7A and 7B which show a lifting trolley 10 fitted with an object gripping means 700 adapted to carry an object with lower edges which are capable of supporting the object's weight. Preferably the object also has flat sides. This embodiment is particularly adapted to lift boxes, crates, whitegoods such as washing machines, or the like.

The object gripping means attached to this embodiment is similar to that of FIGS. 6A and 6B except that the tines (650 of FIGS. 6A and 6B) are replaced with a pair of inward facing generally L shaped gripping arms 730, 740. Each gripping arm 730, 740 is comprised of a vertically extending member 732, 742, which terminates at its lower end in an inwardly facing flange 735, 745. At its upper end, each gripping arm 730, 740 has a hooked protrusion 750 which is adapted to hook over bearing plate 710 to support the weight of the arm 730, 740. Each arm 730, 740 additionally has a suction grip, of the type described above, mounted the inside face of its vertical member 732, 742. Typically the suction grip will be mounted such that its pliable skirt is not able to touch the flange 735, 745. The arms 730, 740 are slideably mounted on the bearing plate 710 in order to allow them to be clamped onto the object by adjusting the spacing between the arms 730, 740. Preferably a mechanical translation means, such as a rack and pinion or the like, can be fitted to one or the other (or both) of the arms 730, 740 to change the spacing between the arms and enable the arms to be clamped onto the object to be carried.

The object gripping means 700 of this embodiment mimics the action of a person's hands and arms in lifting an object. The flanges 735, 745 act like a person's fingers to support the object in a vertical direction while the suction grips 737, 747 act like the palms of the hand to securely hold the object from sideways, and fore and aft movement.

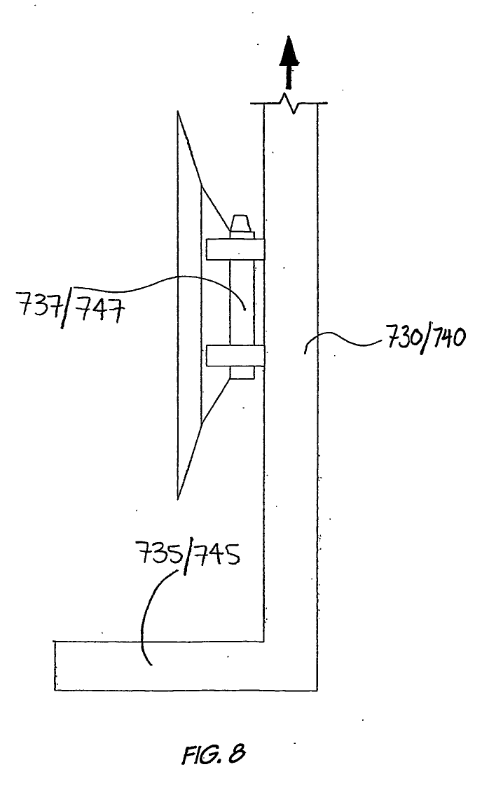

A close up view of the lower end of the gripping arms is depicted in FIG. 8. showing the suction grip 737, 747 and inwardly facing flange 735, 745.

In order to use the trolley 10 with this embodiment of the object gripping means the trolley 10 is manoeuvred into a position such that the arms 730, 740 are on opposite sides of the object to be lifted and the bearing plate 710 rests against the object. The arms are then moved together either by hand or using a mechanical translation means (if one is fitted) until the flanges 735 and 745 are under the object and the suction grips 737, 747 rest against the sides of the object. Next a suction is created in the suction grips 737, 747 by pumping as described above. The object can then be lifted being supported on its lower edges by the flanges 735 and 745 and sides securely held by the suction grips 737, 747.

It should be noted that if the object to be lifted is air permeable such as a cardboard box the suction grips will not be able to form a suction force to securely engage with the object. However, the pliable nature of the skirts of the suction grip allow them to apply a sufficient frictional force on the object to securely grip the object. In this circumstance it is advantageous to have a mechanical means to adjust and maintain the arm spacing so that a clamping force can be applied to the object to be carried.

Once the object gripping means 700 are locked onto the object, the object can be raised using the winch 60 or by tilting the trolley 10 as described above. In order to release the object once it has been conveyed to the desired position the suction (if any) is released and the arms 730, 740 moved apart to release the object.

As will be appreciated by a person skilled in the art the object gripping means described herein are only exemplary embodiments, and other types of object gripping means can be either permanently, removably, or interchangeably attached to the lifting trolley without departing from the scope of the present invention.

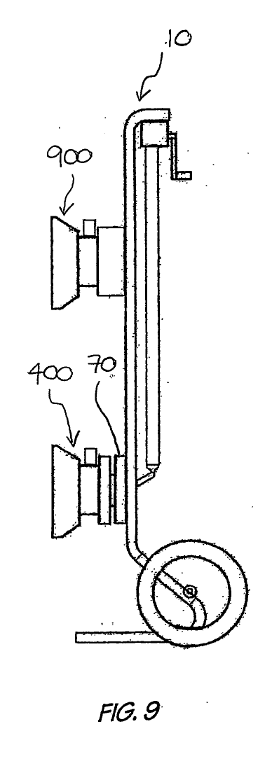

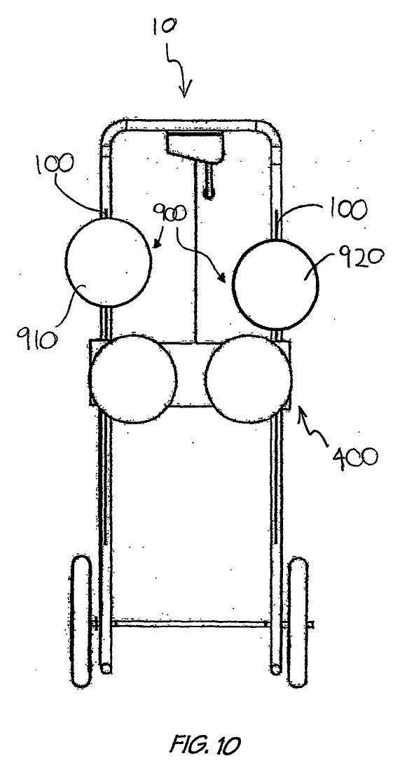

FIGS. 9 and 10 show an embodiment of the present invention which, in addition to having a lifting carriage 70 with object gripping means slideably mounted on its frame, has auxiliary object gripping means 900. The embodiment of FIGS. 9 and 10 are generally the same as that of FIGS. 4A and 4B in so far as the trolley 10 includes a suction type object gripping means 400 mounted on the lifting carriage 70. However the trolley 10 additionally includes a pair of independently moveable suction grips 910/920 which are slideably mounted in the slots 100 on the frame uprights. The suction grips 910/920 are mounted to the frame uprights such that they can be slid from a lower position, adjacent to the lifting carriage in its lowered position (see suction grip 920 in FIG. 10) to a raised position near the top of slot 100 (see suction grip 910 in FIG. 10).

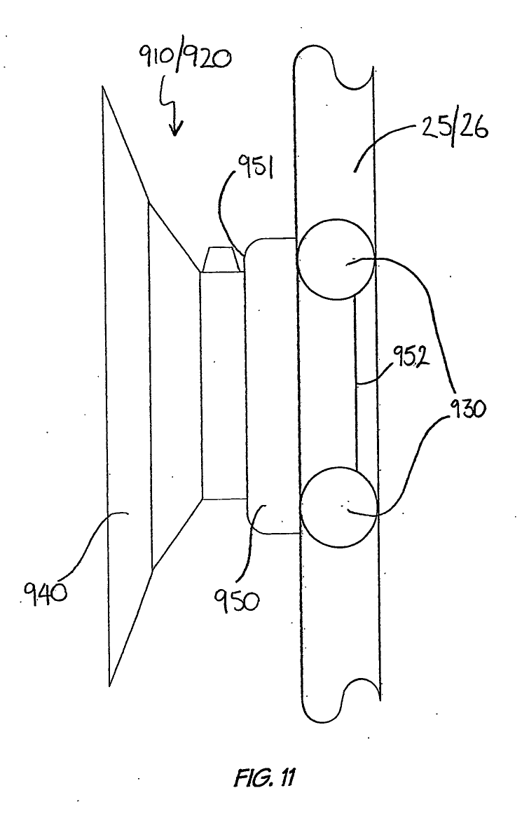

FIG. 11 shows a cutaway side view of one of the auxiliary object gripping means 910/920 showing a means for mounting the object gripping means in a slideable manner on the frame uprights 25/26 of a trolley 10. The mounting method for the auxiliary gripping means 910/920 is similar to that employed for the lifting carriage 70. A suction grip 940 is mounted to the outside edge 951 of a vertically extending support member 950. The support member 950 is sized such that it is a sliding fit in slot 100 in the upright portions 25/26. Thus the support member 950 extends through the slot 100 and is fitted, on its inner edge 952 with a pair of rollers 930. As described above in connection with FIGS. 2 and 3 the rollers are retained with in the uprights 25/26 and thus allow the auxiliary object gripping means 910/920 to slide freely up and down their respective uprights 910/920. As will be appreciated by those skilled in the art, the rollers 930 could be replaced with transverse flanges which hold the support member 950 in the slot 100 such that the auxiliary member can still slide.

In use the auxiliary gripping means are used to provide a more steady grip on an object being lifted. When attached to a part of the object distal to the location of the gripping means, the auxiliary gripping means prevents the object from tipping forward during the lifting and carrying process, thus reducing torque on the lifting carriage and facilitating the raising and lowering of the lifting carriage.

In an alternative embodiment the auxiliary object gripping means can also be coupled together such that they cannot slide independently to one another. Furthermore the gripping means could include a tie down or strap for securely holding the object to the trolley without preventing it from being lifted relative to the trolley frame.

A further embodiment of a lifting apparatus according to the present invention is shown in FIGS. 12 through 16. FIG. 12 shows a side view of this additional embodiment.

The lifting apparatus 1200 is generally similar to the previous embodiments, in that it includes an elongated frame 1210 having a pair of wheels 1270 mounted on an axle 1280 adjacent to its bottom end 1230. The lifting apparatus 1200 also includes a handle portion 1250 at its upper end, on which is mounted a “reverse braking” winch 1255. Mounted on the frame 1210 in a similar fashion to the previous embodiments is lifting carriage 1290. The lifting carriage 1290 is coupled to the winch 1255 via a retractable cable or strap (not shown).

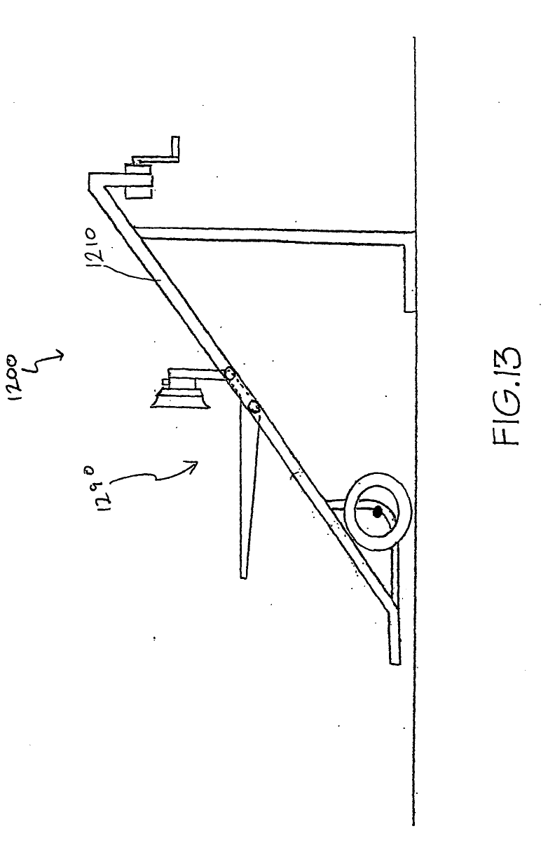

The lifting carriage 1290 includes object gripping means 1275 in the form of a suction grip, and an object support platform 1295. The object support platform 1295 extends generally parallel to the surface on which the lifting apparatus 1200 is resting, and at right angles to the gripping surface of the suction grip 1275. The suction grip 1275 is mounted to the lifting carriage via mounting bracket 1272, and operates in the same fashion of those described in connection with the previous embodiments of the present invention. On the top surface 1285 of the object support platform 1295 there is mounted a ball mat. A ball mat comprises a plurality of ball bearings retained within a plurality of sockets embedded into a mat structure, such that any object placed on the mat can easily be translated across it with minimal friction. The object support platform 1295 preferably extends beyond the edges of the frame 1210 to allow the supporting platform 1295 to come into contact with the object to be lifted, or the surface on which the object to be lifted is resting, Furthermore, the edge of the supporting platform 1295 can be configured to have an engagement means which are adapted to engage with an edge or lip of a surface on which the object to be lifted is resting. Such an arrangement allows the trolley to be temporarily secured to the surface on which the object is resting during the securement of the object to the gripping means and can provide added support of the objects load before the object is engaged on the gripping means. The lifting device 1200 additionally includes a stand or support member 1260 attached to the frame near its upper end, which terminates in a support foot 1261 at its lower end. Turning now to FIG. 13 which shows the lifting device 1200 with the lifting carriage 1290 in a partially raised position.

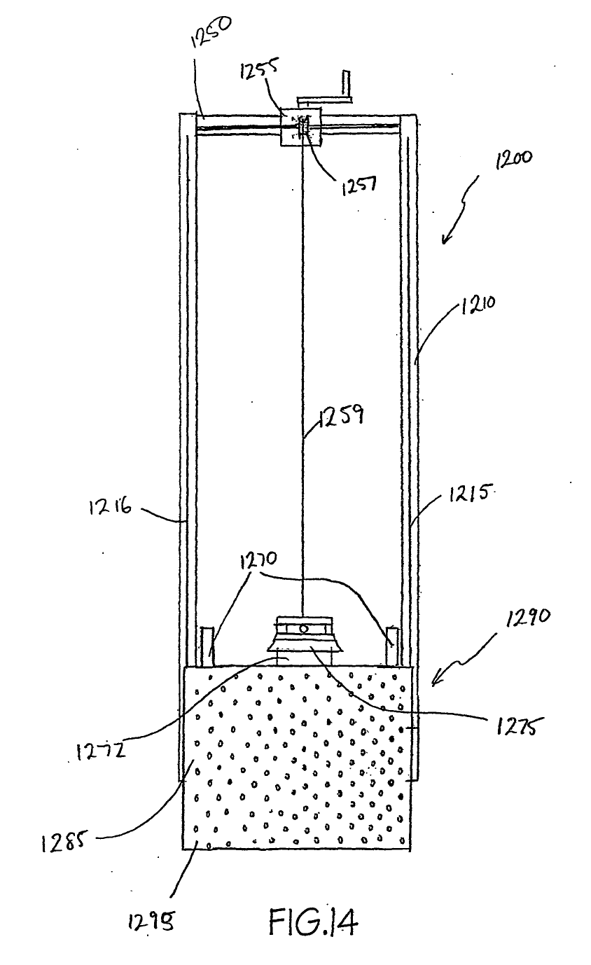

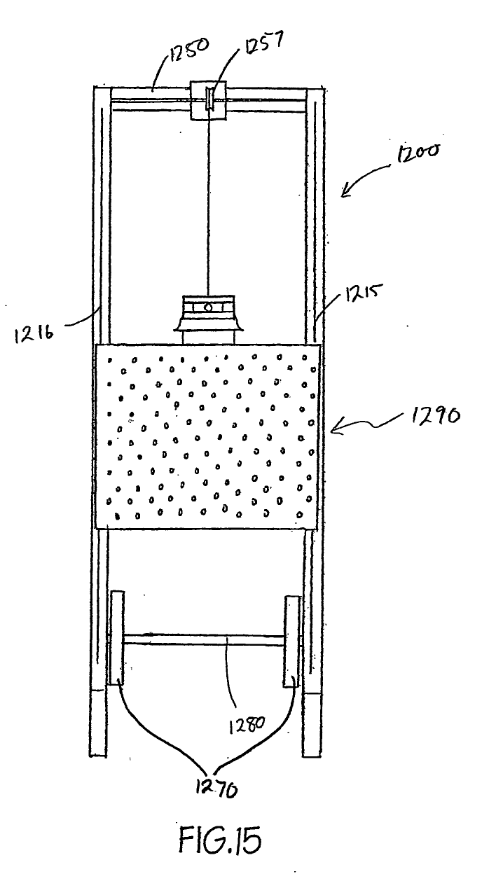

FIGS. 14 and 15 are plan views showing the lifting apparatus of the present embodiment with its lifting carriage in positions generally corresponding to the side views shown in figures 12 and 13 respectively. As can be seen from the plan views (FIGS. 14 and 15), the wheels 1270 are mounted on axle 1280 so that they do not protrude past the outside edge of the frame 1210. Accordingly, the wheels of the present embodiment are less likely to collide with, or become lodged on obstacles in use, making this embodiment particularly advantageous for use in confined spaces.

The plan views also show clearly the ball mats 1285 mounted on the lifting platform 1295 on the lifting carriage 1290. As described above the lifting cable 1259 is attached to the lifting carriage 1290 and extends over a pulley 1257, and down to the winch 1255.

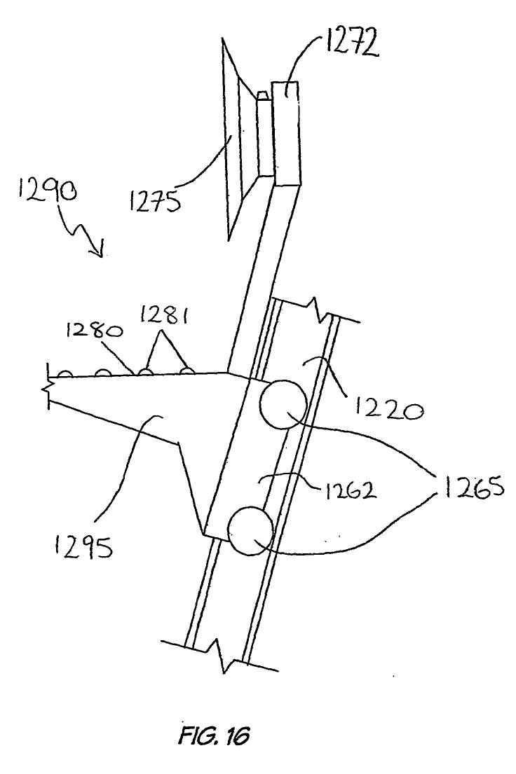

Turning now to FIG. 16 which shows a cut away view of an upright portion of 1220 of the frame 1210 of the lifting apparatus 1200 shown in FIGS. 12 to 15 and illustrates how the lifting carriage 1290 is mounted on the frame 1210. The lifting carriage 1290 is elongate and extends between the two uprights 1220 of the frame 1210. On each end of the lifting carriage there is a downwardly depending flange 1262 with a two pairs of wheels attached thereto. Each flange 1262 extends through slots 1215 and 1216 on the frame member 1220 (as shown in FIGS. 14 and 15) such that the rollers 1265 are free to travel along the uprights 1220 in an identical manner to the previous embodiments.

The object support platform 1295 is formed integrally with the lifting carriage 1290 and is shaped such that its top surface 1280 is maintained generally parallel to the surface on which the lifting device 1200 is resting. The surface 1280 of the object support platform 1295 is preferably fitted with a ball mat or similar friction reducing mechanism. The lifting carriage 1290 additionally includes a suction grip 1275, which operates as described in the previous embodiments, and which is mounted on a bracket 1275. In this embodiment, the gripping surface of the suction grip 1275 is generally perpendicular to the surface 1280 of the lifting platform 1295. However, it should be noted that this angle may be selected such that it suits the particular objects or articles to be lifted.

As described in connection with FIGS. 2 and 3 the lifting carriage 1290 is free to roll up and down the uprights 1220 of the frame 1210 of the lifting device 1200, under control of the actuation means.

The present embodiment is particularly useful for lifting and moving heavy articles in a confined space. In particular, the present embodiment is adapted for lifting galley ovens on aircraft. In use, the lifting apparatus 1200 is manoeuvred into position such that the article to be lifted, eg a galley oven, can be slid onto the lifting platform 1295. Preferably the lifting apparatus 1200 is manoeuvred into a position alongside the object to be lifted, and the object is slid onto the supporting platform 1295 across the supporting platform 1295, rather than from the front of the supporting platform 1295 towards the frame 1210.

As the upper surface 1280 of the supporting platform 1295 is a ball mat the article can be slid easily along the surface of the supporting platform 1295 until it comes into surface engagement with the suction grip 1275. The suction grip can then be activated to grip on to the article as described in connection with the previous embodiments. In order to lift the article, the winch is activated by the user, which retracts the cable 1259 and draws the lifting carriage 1290 up the frame 1210 of the lifting apparatus 1200, thereby lifting the article supported and retained thereon.

Once the object on the lifting platform 1290 is at a sufficient height the lifting apparatus may be manoeuvred to any desired position, using the lifting apparatus in the manner of a standard hand-truck. The support leg 1260 supports the lifting apparatus 1200 in an upright position when the lifting platform 1290 is in a raised position. A user can therefore manoeuvre the trolley with the lifting carriage in a raised position, and if desired, support the lifting apparatus on the foot 1261 without lowering the object.

As will be appreciated by those skilled in the art the foot 1261 may be replaced by wheels or rollers to enable the lifting apparatus to be wheeled in the manner of a trolley. However, as described above, the present embodiment is adapted for use on aircraft which typically have strict floor loading limits. Thus, as foot 1261 provides a relatively large surface on which to support the weight of an article, in comparison to a wheel, use of a foot of this type may prove advantageous even though it may reduce ease of use for the operator.

Typically, a galley oven on an aircraft is wider than the aisle between seats on the aircraft. Thus, in order to move the galley oven through the aircraft to an exit the galley oven must be lifted above the height of the arm rests or seats of the aircraft. As can be seen the present embodiment allows a user to lift the galley oven and hold it in a secure manner with the suction grip 1275 and carry it through the aircraft in a raised position without danger of dropping the oven.

As will be appreciated by those skilled in the art many other embodiments of lifting carriages or object gripping means can be used with the present invention, for example electromagnetic or permanent magnet gripping means. Object gripping means utilising hook and loop fastener may also be used. For example, by attaching a panel of hook type material to the lifting carriage or a bracket mounted thereon, and a corresponding panel of loop type material attached to the article to be lifted the article could be secured to the lifting carriage. Clearly the hook and loop panels can be interchanged on the lifting carriage and object.

It will be understood that the invention disclosed and defined herein extends to all alternative combinations of two or more of the individual features mentioned or evident from the text or drawings. All of these different combinations constitute various alternative aspects of the invention.

The foregoing describes embodiments of the present invention and modifications, obvious to those skilled in the art can be made thereto, without departing from the scope of the present invention.

1. A lifting trolley for lifting and conveying an object, said lifting trolley including;
a frame having an operatively lower wheeled end supported on a wheel arrangement, and an operatively upper end;
a lifting carriage slideably mounted on said frame;
actuating means for moving said lifting carriage along said frame between lowered and raised positions; and
object gripping means extending from said lifting carriage, said gripping means being adapted to grip said object to be conveyed and to allow said object to be lifted by operation of said actuating means on said lifting carriage.

2. A lifting trolley as claimed in claim 1 in which the object gripping means is arranged to form a surface engaging grip on a surface of said object.

3. A lifting trolley as claimed in claim 2 in which said object gripping means includes at least one releasable suction grip.

4. A lifting trolley as claimed in claim 2 in which said object gripping means includes at least one releasable electromagnetic grip.

5. A lifting trolley as claimed in claim 1 in which said object gripping means is rotatably or slidably mounted on said lifting carriage for allowing the orientation or position of an object to be adjusted when in a gripped position.

6. A lifting trolley as claimed in claim 1 which further includes object supporting means coupled to said lifting carriage and adapted to at least partially support the weight of said object.

7. A lifting trolley as claimed in claim 6 wherein said object supporting means includes a pair of support tines.

8. A lifting trolley as claimed in claim 6 wherein said object supporting means includes a support platform.

9. A lifting trolley as claimed in claim 8 wherein said support platform includes glide means adapted to allow the object to be slid along said support platform until said object comes into surface engagement with said object gripping means.

10. A lifting trolley as claimed in claim 9 wherein said glide means is a ball mat.

11. A lifting trolley as claimed in claim 1 in which said actuation means is selected from one of the following types of actuation means:
winch, hoist or jack.

12. A lifting trolley as claimed in claim 1 in which said frame is substantially L shaped, with the horizontal arm of the L constituting a support portion which maintains said trolley in a substantially vertical orientation when at rest.

13. A lifting trolley as claimed in claim 1 in which said frame is substantially the shape of a right-triangle, wherein the lifting carriage is slideably mounted along a portion of the frame lying along the hypotenuse of the triangle such that an object gripped by the gripping means is ramped upwards at an acute angle with respect to a surface supporting said lifting trolley.

14. A lifting trolley as claimed in claim 1 in which said object gripping means is detachably mounted on said lifting carriage.

15. A lifting trolley as claimed in claim 14 in which said lifting trolley includes a plurality of different types of object gripping means which can be interchangeably mounted on said lifting carriage, said object gripping means being selected from a group including:
a suction grip, an electromagnetic grip.

16. A lifting trolley for lifting and conveying an object, said lifting trolley including;
a frame having an operatively lower wheeled end supported on a wheel arrangement, and an operatively upper end;
a lifting carriage slideably mounted on said frame;
actuating means for moving said lifting carriage along said frame between lowered and raised positions; and
object gripping means extending from said lifting carriage, said gripping means being adapted to engage said object to be conveyed in a surface engaging grip which relies on surface features of at least one face of the object rather than the dimensions or shape of the object.
